(19) United States
(12) Patent Application Publication
(10) Pub. No.: US 2014/0183235 A1
(43) Pub. Date: Jul. 3, 2014

(54) ROOF RACK LEG

(71) Applicant: Peter Douglas Hubbard, Christchurch (NZ)

(72) Inventor: Peter Douglas Hubbard, Christchurch (NZ)

(73) Assignee: Hubco Automotive Limited, Ackland (NZ)

(21) Appl. No.: 14/009,789

(22) PCT Filed: Apr. 5, 2012
(86) PCT No.: PCT/IB12/00686

§ 371 Date: Jan. 20, 2014

(30) Foreign Application Priority Data
Apr. 8, 2011 (NZ) 592162

(51) Int. Cl. B60R 9/058

(52) U.S. Cl. CPC B60R 9/058
USPC 224/309

(57) ABSTRACT

A leg is described to attach a roof rack crossbar to a vehicle rail. The leg is particularly suited to fitting a roof rack to a flush rail on a vehicle although may be used on other rail types. Also described in a kit and roof rack utilizing the leg.

### TECHNICAL HELD

The application relates to a roof rack leg. More specifically, the application relates to a leg for attaching a roof rack crossbar to vehicle roof rails.

### BACKGROUND ART

Roof racks are well known and are manufactured in a variety of configurations. Typically, roof racks include a crossbar with a leg on each end of the crossbar to support the crossbar and attach the crossbar to the roof of a vehicle. The legs attach to a mounting system on the roof of a vehicle and serve the purpose of securing the roof rack to the vehicle.

Different vehicles have different types of mounting systems to which roof racks may be mounted. Vehicles have typically been manufactured with either raised rail mounting systems or gutter mounting systems. Recently, vehicle manufacturers have introduced flush rails. Rush rails are characterised by a discreet profile, being slightly raised features that are fixed to the vehicle roof along the length of the rails. They lie approximately flush with the surface of the roof, hence the name. The cross section of a flush rail generally includes small protrusions on the sides of the rail facing externally and internally to the vehicle, respectively. These protrusions create a lip or contour along each side of the rail that can be used for gripping. The exact shapes of these gripping surfaces vary depending on the vehicle.

It is particularly challenging to attach roof racks to flush rails, as these types of rails do not lend themselves to being entirely enclosed by the leg of a roof rack. As a result, there is little surface area available for securing the leg to the flush rail.

Additionally, flush rails do not offer recessed features, such as those offered by gutters, to receive anchoring members with which a leg may be secured to the roof. Further, since flush rails are often manufactured as hydro-formings, they do not have holes to act as fastening points and inserting holes would allow access of moisture into the hollow part of the extrusion which is undesirable.

Known roof rack legs that attach specifically to flush rails do not have means to be secured to the lip along the inner, or internally-facing, surface of the flush rail. These legs attach only to the outer, or externally-facing, surface of the flush rail, thus having a tendency to slide along the flush rail when urged for example by movement of the vehicle or in the event of a crash or sudden impact. As a result, the user is presented with the disadvantage of having a potentially unstable roof rack and/or unstable load or at least a rack that may not meet standard crash test criteria.

An unstable roof rack and/or load can create a hazardous distraction for the driver of the vehicle. Worse, due to the sliding of the roof rack, the roof rack or the attached load may come loose from the vehicle, presenting a serious hazard to the driver as well as to the drivers of other vehicles. The risk of such an incident occurring is especially high in a crash situation.

Other known roof rack legs that attach to flush rails are designed to attach to a variety of roof top attachment points and typically comprise a fixably mounted leg attachment component. As these types of legs must be attached to the roof with visible anchoring members, they are generally larger than legs specifically designed to attach to one kind of roof top mounting system. These legs present an aesthetic disadvantage by distracting from the discreet shape and aerodynamic appearance vehicle flush rails.

It is an object of the present invention to address the foregoing problems or at least to provide the public with a useful choice.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description that is given by way of example only.

### SUMMARY OF THE INVENTION

The application broadly relates to a leg that allows for mounting of a roof rack crossbar to a vehicle rail. The leg is particularly well adapted to fit a cross bar to a flush rail although may be fitted to other types of vehicle rail.

In a first embodiment there is provided a leg for a vehicle roof rack linking a vehicle rail to a crossbar wherein the leg includes:

a crossbar receiver to support a crossbar that includes a crossbar receiving portion;

a fixed portion that communicates with a first vertical surface of the rail; and

a movable clamping portion that includes a clamp arm and a clamp pad which communicates with an opposing second vertical surface of the rail thereby releasably attaching the leg to a rail about the first and second vertical rail surfaces;

wherein the clamp arm is angled towards the rail second vertical surface and the arm nests a complementary wedge shaped clamp pad between the arm interior and rail second vertical surface; and

wherein, as the clamp portion is moved against the rail second vertical surface to tighten the leg to the rail, the clamp arm pulls the leg onto the rail by virtue of the wedge action of the clamp pad and, any upwards force on the leg causes the arm and pad to tighten further against the rail preventing upward movement.

In a second embodiment there is provided a leg for a vehicle roof rack linking a vehicle rail to a crossbar wherein the leg includes:

a crossbar receiver to support a crossbar that includes a crossbar receiving portion;

a fixed portion that communicates with a first vertical surface of the rail; and

a movable clamping portion that includes a clamp arm and a clamp pad which communicates with an opposing second vertical surface of the rail thereby releasably attaching the lag to a rail about the first and second vertical rail surfaces;

wherein the clamp arm has a ridged horizontal cross-section which interlocks with a complementary ridge-shaped clamp pad located between the clamp arm and rail second surface; and

wherein, on application of a horizontal force to the leg, the clamp pad ridges are shaped with a sufficient angle so as to cause a tightening force to occur between the rail and clamp arm via the clamp pad thereby preventing movement of the leg along the rail.

In a third embodiment there is provided a leg for a vehicle roof rack linking a vehicle rail to a crossbar wherein the leg includes:

a crossbar receiver to support a crossbar that includes a crossbar receiving portion;

a fixed portion that communicates with a first vertical surface of the rail; and

a movable clamping portion that includes a clamp arm and a clamp pad which communicates with an opposing second vertical surface of the rail thereby releasably attaching the leg to a rail about the first and second rail vertical surfaces;

wherein the clamp arm is angled towards the rail second vertical surface and the arm nests a complementary wedge shaped clamp pad between the arm interior and rail second vertical surface wherein, as the clamp portion is moved against the rail second vertical surface to tighten the leg to the rail, the clamp arm pulls the leg onto the rail by virtue of the wedge action of the clamp pad and, any upwards force on the leg causes the arm and pad to tighten further against the rail preventing upward movement; and,

wherein the clamp arm has a ridged horizontal cross-section which interlocks with a complementary ridge-shaped clamp pad located between the clamp arm and rail second vertical surface, wherein, on application of a horizontal force to the leg, the clamp pad ridges are shaped with a sufficient angle so as to cause a tightening force to occur between the rail and clamp arm via the clamp pad thereby preventing movement of the leg along the rail.

In a fourth embodiment there is provided a kit of parts for a vehicle roof rack, including at least one leg substantially as described above, In a fifth embodiment there is provided a vehicle roof rack including at least one leg substantially as described above.

The above leg provides a styled, aesthetically pleasing attachment leg for securing a roof rack to a vehicle rail. The design may be particularly advantageous in securing a roof rack to a flush rail, as the leg is adapted to grip both vertical surfaces of the rail. The design may prevent the roof rack from sliding horizontally along the rail, allowing the user to avoid distracting or hazardous movement of the roof rack or attached load. Further, the leg resists undesired release of the roof rack from the rail in the event of sudden vertical force on the roof rack, as in a sudden stop or crash situation.

### BRIEF DESCRIPTION OF THE DRAWINGS

Further aspects of the present invention will become apparent from the following description that is given by way of example only and with reference to the accompanying drawings in which;

FIG. 1 illustrates an assembled perspective view from above of one embodiment of the leg in a the closed position around a vehicle rail;

FIG. 2 illustrates a detail elevation view of the leg in a closed position around a vehicle rail;

FIG. 3 illustrates a detail section view of the leg in a dosed position around a vehicle rail;

FIG. 4 illustrates a detail elevation view of the leg in an open position;

FIG. 5 illustrates a detail elevation view of the leg in a dosed position around a first alternative vehicle rail profile; and

FIG. 6 illustrates a detail elevation view of the leg in a dosed position around a second alternative vehicle rail profile.

### DETAILED DESCRIPTION

As noted above, the invention broadly relates to a leg that allows for mounting of a roof rack crossbar to a vehicle rail. The leg is particularly well adapted to fit a cross bar to a flush rail.

For the purposes of this specification, the term crossbars refers broadly to a roof rail or any load carrying apparatus configured to be releasably clamped or attached to a roof rack leg.

The term ‘flush bar’ refers to a type of crossbar where the ends of the crossbar are held within the legs of the roof rack (that is, the ends of the crossbar do not extend beyond the legs of the roof rack). In this form of roof rack, each end of the crossbar is typically flush with the respective leg of the roof rack supporting that end. The term ‘through bar’ refers to a vehicle roof rack crossbar that, when the crossbar is attached to end fittings, the ends of said crossbar extend past the end fittings and may include end caps at one or both ends of the crossbar.

The term ‘flush rail’ refers to a vehicle rail characterised by a discreet profile, being a raised feature fixed to the roof along the length of the rails. This type of rail lies approximately flush with the surface of the roof, hence the name.

The term ‘leg’ refers to a component of a vehicle roof rack that connects a vehicle crossbar to a vehicle rail and includes componentry for attachment to a vehicle. This is sometimes referred to as a fitting kit. The term ‘surface’ refers to a largely planar region of an item but which may include lips, contours, depressions or protrusions within this planar region.

The term ‘vertical’ refers to a surface which is approximately 90° from a horizontal plane, but it should be appreciated the range of angles from the horizontal may vary. For example this may include, but is not limited to a range of 60°-120°. in a first embodiment, there is provided a leg for a vehicle roof rack linking a vehicle rail to a crossbar wherein the leg includes:

a crossbar receiver to support a crossbar that includes a crossbar receiving portion;

a fixed portion that communicates with a first vertical surface of the rail; and

a movable clamping portion that includes a clamp arm and a clamp pad which communicates with an opposing second vertical surface of the rail thereby releasably attaching the leg to a rail about the first and second vertical rail surfaces;

wherein the clamp arm is angled towards the rail second vertical surface and the arm nests a complementary wedge shaped clamp pad between the arm interior and rail second vertical surface; and

wherein, as the clamp portion is moved against the rail vertical second surface to tighten the leg to the ran, the clamp arm pulls the leg onto the rail by virtue of the wedge action of the clamp pad and, any upwards force on the leg causes the arm and pad to tighten further against the rail preventing upward movement.

The angle of the clamp arm relative to a vertical plane may be 5° to 30°. Alternatively, the angle relative to a vertical plane may be 10° to 20°. Alternatively, the angle of the clamp arm relative to a vertical plane may be approximately 15°. To accommodate a variety of rail types, the internal angle of the angled cross-section may vary. While examples of potential angles are provided, it should be appreciated that the angle is in part dictated by the rail angle chosen by the vehicle manufacturer and the angles described herein may vary accordingly.

In a second embodiment there is provided a leg for a vehicle roof rack linking a vehicle rail to a crossbar wherein the leg includes:

a crossbar receiver to support a crossbar that includes a crossbar receiving portion;

a fixed portion that communicates with a first vertical surface of the rail; and

a movable clamping portion that includes a clamp arm and a clamp pad which communicates with an opposing second vertical surface of the rail thereby releasably attaching the leg to a rail about the first and second vertical rail surfaces;

wherein the clamp arm has a ridged horizontal cross-section which interlocks with a complementary ridge-shaped clamp pad located between the clamp arm and rail second surface; and

wherein, on application of a horizontal force to the leg, the clamp pad ridges are shaped with a sufficient angle so as to cause a tightening force to occur between the rail and clamp arm via the clamp pad thereby preventing movement of the leg along the rail.

The ridges may have an elongated V-shape cross-section Le, with a very shallow internal angle. The size of the ridge should be sufficient to have the damp arm and damp pad mesh together when subjected to a horizontal force.

The clamp arm and clamp pad may interact so that on application of a horizontal force to the leg, the ridge surfaces may act together to apply a force perpendicular to the rail against the clamp pad, thereby tightening the grip of the leg on the rail and thereby resisting a sliding movement of the leg along the rail in a horizontal direction.

In the above embodiment, each ridge angle may be set at an angle of approximately 2° to 15° from the second vertical rail surface. Alternatively, each ridge angle may be set at an angle of approximately 5° to 10° from the second vertical rail surface.

The clamping portion in the above embodiments may further include a material sandwiched between the clamp pad and clamp arm with a coefficient of friction sufficient to allow movement of the clamp pad against the clamp arm. The coefficient of friction of the material may range from 0.46 to 0.52. The material may be a hard plastic layer with a Rockwell hardness number from 110 to 220. Alternatively, the material may be a membrane or coating layer.

The clamp pad may be produced from a friction-inducing material. The clamp pad may have a coefficient of friction sufficient to prevent the pad from slipping against the vehicle rail, in one embodiment the coefficient of friction of the clamp pad may be equal to or greater than 1.0. The clamp pad may be manufactured from a thermoplastic rubber or a thermoplastic elastomer. The pad may be manufactured from a soft and resilient material, in one embodiment having a hardness of 50-90 shore A. The shape of the clamp pad interior or rail facing surface may be moulded to suit the shape of the rail. As should be appreciated, vehicle manufacturers have particular shaped rail that, while broadly having similar features, the specific surface may have minor variations to which the pad may be moulded to lit or alternatively, made sufficiently resilient and deformable to be forced to fit a particular shape.

The leg may include a mechanical fastener that causes linear movement of the clamping portion towards or away from the second rail surface.

Actuation of the tightening mechanism may either draw the clamp arm towards the second surface of the rail or away from the second surface of the rail.

The tightening mechanism may preferably be located on the leg near the first vertical surface of the rail for easy accessibility. Optionally, the tightening mechanism may be located at either side of the leg or near the second vertical surface of the rail. Multiple tightening mechanisms may also be used without departing from the scope of the application.

In the above embodiments, the tightening mechanism may be a threaded fastener that threads into a thread in the leg e.g. in the arm extension of the clamp arm. Alternatively the fastener may be a bolt with a bearing surface such as a nut. Other tightening mechanism devices may also be used such as linear actuators, rack and pinion devices or pulley devices.

The fixed arm portion may have a contoured recess that receives at least one contour located on the first vertical surface of the rail such that the fixed arm portion grips the rail around the contour of the first surface of the rail.

In one embodiment the fixed arm portion may be formed from a rigid material e.g. steel or a rigid plastic. Alternatively, the fixed arm portion may be formed from a mix of rigid and semi-rigid material or friction-inducing material such as a rigid piece with a semi-rigid rubber lining that abuts the rail.

In the above embodiments, the leg may also include a resilient material fitting or fittings sandwiched between the fixed arm and the rail and optionally, above the rail in the bridge section of the leg defined by the space between the fixed portion and the clamp portion. The resilient material may be a rubber or elastomer material. The shape of the resilient material may be defined on one side by the shape of the leg and on the rail side, defined by the shape of the rail.

In the above embodiments, the first vertical surface of the rail is the outer surface of the rail when mounted to a vehicle.

In the above embodiments, the second vertical surface of the rail may be the inner surface of the rail when mounted to a vehicle.

For completeness, the term ‘outer’ refers to the vertical side of the rail facing away from the vehicle roof and ‘inside’ refers to the side facing towards the vehicle roof.

In the above embodiments, the rail may be a flush rail.

As noted above, flush rails present particularly challenging problems in design of a leg for attachment owing to the minimal surface area for attachment. While the leg is particularly well suited for flush rails, it should be appreciated that the leg may be used for various rail designs and the application is not limited to purely legs that attach to flush rails.

In a third embodiment, there is provided a leg for a vehicle roof rack linking a vehicle rail to a crossbar wherein the leg includes:

a crossbar receiver to support a crossbar that includes a crossbar receiving portion;

a fixed portion that communicates with a first vertical surface of the rail; and

a movable clamping portion that includes a clamp arm and a clamp pad which communicates with an opposing second vertical surface of the rail thereby releasably attaching the leg to a rail about the first and second vertical rail surfaces;

wherein the clamp arm is angled towards the rail second vertical surface and the arm nests a complementary wedge shaped clamp pad between the arm interior and rail second vertical surface wherein, as the clamp pardon is moved against the rail second vertical surface to tighten the leg to the rail, the clamp arm pulls the leg onto the rail by virtue of the wedge action of the clamp pad and, an upwards force on the leg causes the arm and pad to tighten against the rail preventing upward movement; and,

wherein the clamp arm has a ridged horizontal cross-section which interlocks with a complementary ridge-shaped clamp pad located between the clamp arm and rail second vertical surface, wherein, on application of a horizontal force to the leg, the clamp pad ridges are shaped with a sufficient angle so as to cause a tightening force to occur between the rail and clamp arm via the clamp pad thereby preventing movement of the leg along the rail.

In the third embodiment above, the angle of the clamp arm relative to a vertical plane may be 5° to 30°. Further, each ridge angle may be set at an angle of approximately 2° to 15° from the second rail surface.

In the third embodiment, each ridge angle may be set at an angle of approximately 2° to 15° from the second rail surface. Alternatively, each ridge angle may be set at an angle of approximately 5° to 10° from the second rail surface.

The clamping portion in the third embodiment may further include a material sandwiched between the clamp pad and clamp arm with a coefficient of friction sufficient to allow movement of the clamp pad against the clamp arm. The coefficient of friction of the material may range from 0.46 to 0.52. The material may be a hard plastic layer with a Rockwell hardness number from 110 to 220. Alternatively, the material may be a membrane or coating layer.

The leg of the third embodiment may be used to attach a roof rack to a flush rail.

In a fourth embodiment, there is provided a kit of parts for a vehicle roof rack including at least one leg substantially as described above.

As may be appreciated, the leg may be sold as a kit of parts to be installed by the buyer optionally with one or more other roof rack parts such as a cross bar.

In a fifth embodiment, there is provided a vehicle roof rack including at least one leg substantially as described above.

It should be noted that whilst separate embodiments have been discussed above, the different options and extra features described in respect of one embodiment may also be applied to other embodiments.

Advantages of the above leg, kit and roof rack should be apparent including provision of a simple and efficient means to secure a roof rack to a vehicle rail, particularly a flush rail. The design is such that the leg grips the rail about both the first vertical surface and second vertical surface. The leg resists sliding horizontally along the rail, allowing the user to avoid distracting or hazardous movement of the roof rack or attached load. Further, the leg resists undesired release of the roof rack from the rail in the event of sudden vertical force on the roof rack, as in a sudden stop or crash situation. Rather, the leg tightens its grip on the rail in reaction to a vertical force on the roof rack. The leg also has the advantage of being styled and aesthetically pleasing so as not to detract from the aerodynamic appearance of the vehicle, particularly of vehicles with flush rails.

### WORKING EXAMPLES

The leg is now described with reference to a detailed description of an embodiment of the leg.

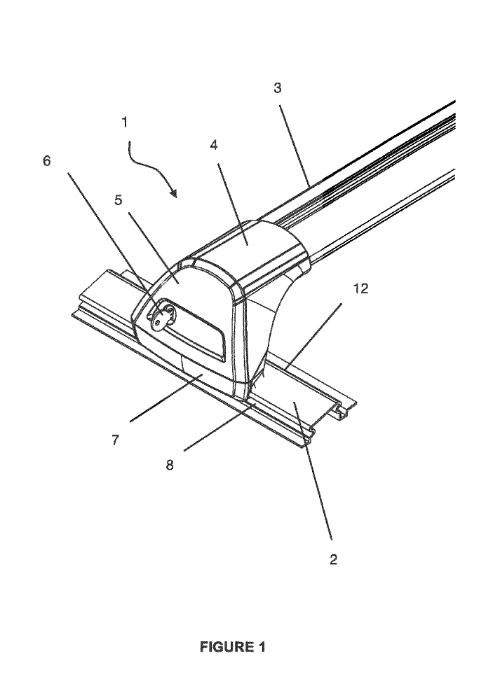

Referring to FIG. 1, the leg, generally indicated by arrow 1, has a styled, aesthetically appealing shape including a cross bar receiver portion 4 for receiving a cross bar 3. From the sides of the vehicle (not shown), the only visible portions of the leg 1 are the fixed arm 7 and lock cover 5 that attaches to the rail 2. The key 6 is shown in a locked orientation. When locked, the cover 5 may not be removed, thus hiding the tightening mechanism inside and the position of the leg 1 is fixed in relation to the rail 2. As shown, the log 1 is fixed between a first vertical surface 8 of the rail 2 and a second vertical surface 12 of the rail 2.

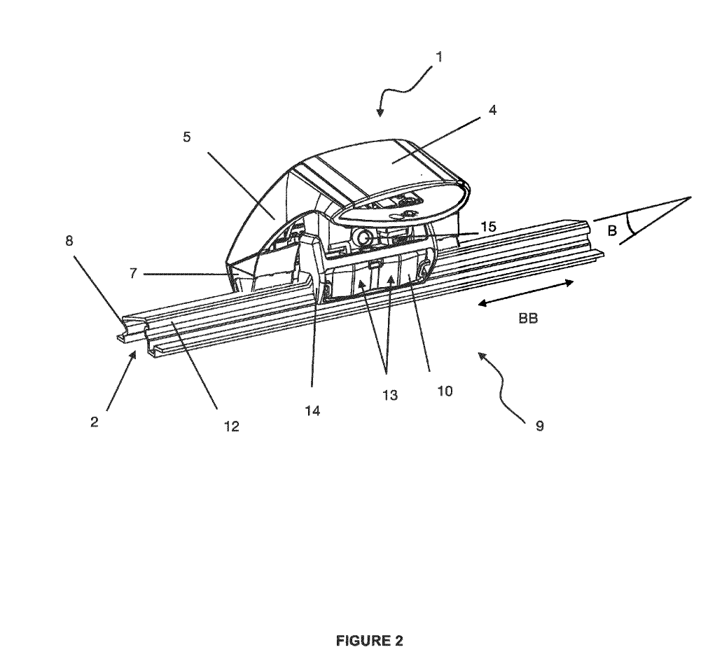

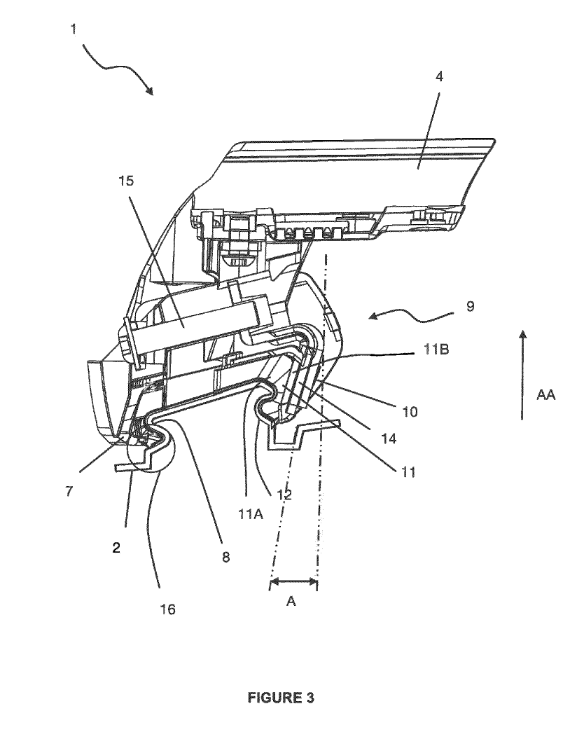

FIG. 2 illustrates the leg 1 in a dosed position around the rail 2 from the vehicle roof side of the rail 2. The fixed portion 7 of the leg is hidden from view while the clamping portion generally indicated by arrow 9 is shown. As noted above, the clamping portion includes a clamp pad 11 (best seen in FIG. 3) and a clamp arm 10. The clamping portion 9 may also include a hard plastic material or coating 14 sandwiched between the clamp arm 10 and clamp pad 11. The clamp arm 10 includes ridged sections 13 that interlock with complementary ridged portions in the clamp pad 11 and sandwiched plastic layer 14. These ridges act to prevent displacement of the leg 1 in a horizontal direction generally indicated by arrow BB in FIG. 2. The ridges may have a relatively shallow angle relative to the rail indicated by angle B in FIG. 2. As noted above this angle may range of 2 to 15 degrees, in one embodiment being 5-10 degrees. This angle is very important as deep ridges and light ridges would result in slippage of the leg along the rail whereas, angles in the range noted results in a strong gripping force against the rail 2 first 8 and second 12 vertical surfaces.

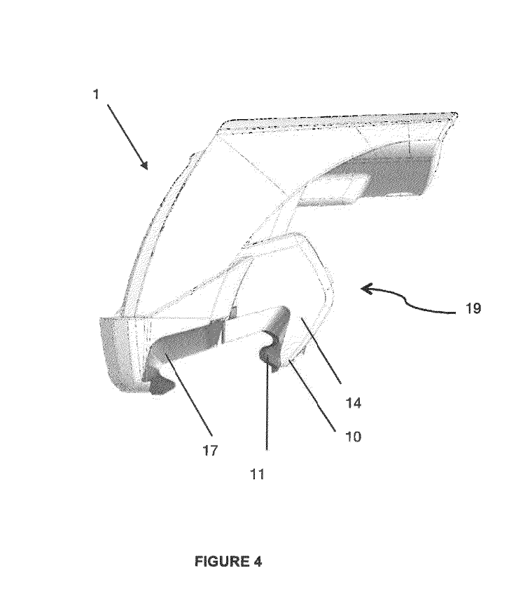

FIG. 3 illustrates further detail on how the leg 1 attaches to the rail 2. The leg 1 includes a fixed portion 7 that engages the first vertical surface 8 of the rail 2. A piece of resilient material such as rubber or an elastomer 17 (best seen in FIG. 4) may be inserted between the first rail surface 8 and the fixed portion 7. This rubber may also extend to be wedged between the bridge portion of the leg over the top of the rail 2. As can be seen in FIG. 3, the clamping portion 9 essentially includes three key parts in the embodiment shown. The clamping portion 9 includes a clamp arm 10, a clamp pad 11 and a hard plastic material 14 sandwiched between. The clamp arm has a V-shaped cross section with the arm 10 being directed towards the rail 2. The arm 10 may have an angle of between 5 to 30 degrees from the vertical towards the rail as shown by angle A in FIG. 3. This angle is very important to ensuring that the clamping portion is drawn towards the rail 2 on tightening of the portion to the rail e.g. via fastener 15. Also, on application of an upward force generally indicated by arrow AA, the shape of the arm 10 and complementary shape of the clamp pad 11 act to further draw the arm in towards the rail 2 second vertical surface 12. Also important in achieving the clamping forces desired is material selection and use of materials with varying coefficients of friction. Ideally that clamp pad is made of a material with a coefficient of friction greater than 1 while the hard plastic 14 (which may also be a membrane, a coating) has a lower coefficient of friction e.g. 0.46 to 0.52 so that the plastic can slip against the clamp arm 10 which may be metal, the slippage resulting in the arm 10 moving towards the rail 2 and applying a greater clamping force.

FIG. 4 illustrates the leg 1 in an open position and released from the rail (not shown). The tightening mechanism 15 (best seen in FIG. 3) has been loosened. In this position the leg may be lifted from the rail 2. One advantage of this release process is that the whole roof rack assembly including the leg(s) and rack and any accessories may be lifted from the roof quickly and easily.

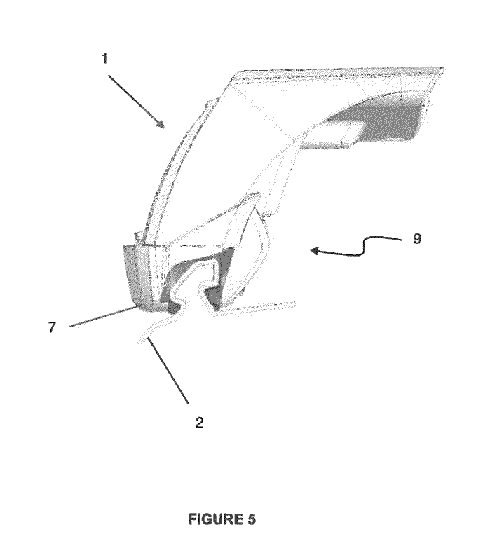

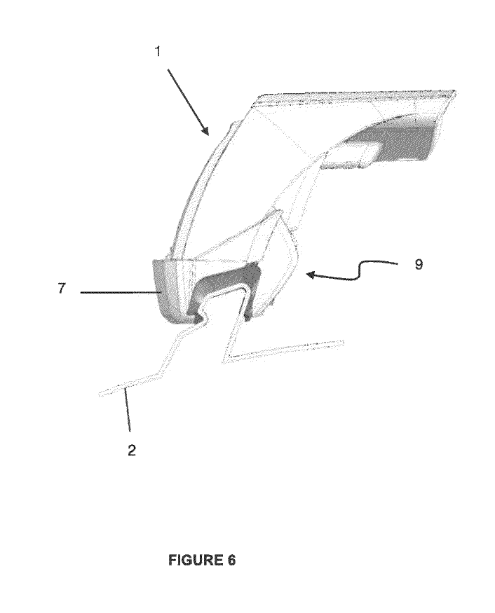

FIGS. 5 and 6 illustrate how the leg 1 may be fitted to other shapes of flush rail 2. Flush rails 2 have a generally similar construction Le, a continuous profile along the length of the vehicle roof with no apertures between the rail 2 and vehicle but they can vary somewhat in contours, lips etc. As illustrated, the leg 1 of this application may be fitted to a variety of different shaped rails and therefore has more commercial use than a leg which only fits one type of rail 2.

Aspects of the present invention have been described by way of example only and it should be appreciated that modifications and additions may be made thereto without departing from the scope of the claims herein.

1. A leg for a vehicle roof rack linking a vehicle rail to a crossbar wherein the leg includes:
a crossbar receiver to support a crossbar that includes a crossbar receiving portion;
a fixed portion that communicates with a first vertical surface of the rail; and
a movable clamping portion that includes a clamp arm and a clamp pad which communicates with an opposing second vertical surface of the rail thereby releasably attaching the leg to a rail about the first and second vertical rail surfaces;
wherein the clamp arm is angled towards the rail second vertical surface and the arm nests a complementary wedge shaped clamp pad between the arm interior and rail second vertical surface; and
wherein, as the clamp portion is moved against the rail second vertical surface to tighten the leg to the rail, the clamp arm pulls the leg onto the rail by virtue of the wedge action of the clamp pad and, any upwards force on the leg causes the arm and pad to tighten further against the rail preventing upward movement.

2. The leg as claimed in claim 1, wherein the angle of the clamp arm relative to a vertical plane is 5° to 30°.

3. The leg as claimed in claim 1, wherein the angle of the clamp arm relative to a vertical plane is 10° to 20°.

4. The leg as claimed in claim 1, wherein the angle of the clamp arm relative to a vertical plane is approximately 15°.

5. A leg for a vehicle roof rack linking a vehicle rail to a crossbar wherein the leg includes:
a crossbar receiver to support a crossbar that includes a crossbar receiving portion;
a fixed portion that communicates with a first vertical surface of the rail; and
a movable clamping portion that includes a clamp arm and a clamp pad which communicates with an opposing second vertical surface of the rail thereby releasably attaching the leg to a rail about the first and second vertical rail surfaces;
wherein the clamp arm has a ridged horizontal cross-section which interlocks with a complementary ridge-shaped clamp pad located between the clamp arm and rail second vertical surface; and
wherein, on application of a horizontal force to the leg, the clamp pad ridges are shaped with a sufficient angle so as to cause a tightening force to occur between the rail and clamp arm via the clamp pad thereby preventing movement of the leg along the rail.

6. The leg as claimed in claim 5, wherein each ridge angle is set at an angle of approximately 2° to 15° from the second rail surface.

7. The leg as claimed in claim 5, wherein each ridge angle is set at an angle of approximately 5° to 10° from the second rail surface.

8. The leg as claimed in claim 5, wherein the clamping portion further includes a material sandwiched between the clamp pad and clamp arm with a coefficient of friction sufficient to allow movement of the clamp pad against the clamp arm.

9. The leg as claimed in claim 8, wherein the coefficient of friction of the material ranges from 0.46 to 0.52.

10. The leg as claimed in claim 8, wherein the material is a hard plastic layer which has a Rockwell hardness number from 110 to 220.

11. The leg as claimed in claim 8, wherein the material is a membrane or coating layer.

12. The leg as claimed in claim 5, wherein the clamp pad is produced from a friction-inducing material such as a thermoplastic rubber or a thermoplastic elastomer.

13. The leg as claimed in claim 12, wherein the pad has a hardness of 50-90 shore A.

14. The leg as claimed in claim 1, wherein the leg includes a mechanical fastener that causes linear movement of the clamping portion towards or away from the second vertical rail surface.

15. The leg as claimed in claim 1, wherein the fixed arm portion has a contoured recess that receives at least one contour located on the first vertical surface of the rail such that the fixed arm portion grips the rail around the contour of the first surface of the rail.

16. The leg as claimed in claim 5, wherein the clamp arm is angled towards the rail second vertical surface and the arm nests a complementary wedge shaped clamp pad between the arm interior and rail second vertical surface wherein, as the clamp portion is moved against the rail second vertical surface to tighten the leg to the rail, the clamp arm pulls the leg onto the rail by virtue of the wedge action of the clamp pad and, any upwards force on the leg causes the arm and pad to tighten further against the rail preventing upward movement.

17. The leg as claimed in claim 16, wherein the angle of the clamp arm relative to a vertical plane is 5° to 30°.

18. The leg as claimed in claim 16, wherein each ridge angle is set at an angle of approximately 2° to 15° from the second vertical rail surface.

19. (canceled)

20. A kit of parts for a vehicle roof rack including at least one leg as claimed in claim 1.

21. A vehicle roof rack including at least one leg as claimed in claim 1.
